(19) United States
(12) Patent Application Publication
(10) Pub. No.: US 2011/0071683 A1
(43) Pub. Date: Mar. 24, 2011

(54) Mounting Apparatus for a Television or Display

(76) Inventor: Paul Turton, Hertfordshire (GB)

(21) Appl. No.: 12/620,592

(22) Filed: Nov. 18, 2009

(30) Foreign Application Priority Data
Sep. 21, 2009 (GB) 0916563.0

(51) Int. Cl. G05B 19/02; F16M 13/00; A47B 96/06; G01M 1/38

(52) U.S. Cl. 700/275; 248/274.1; 248/295.11; 248/201

(57) ABSTRACT

A mount apparatus 1 for a flat panel display (FPD) comprises a number of interconnected components which include a set of wall brackets 2, 3, an electro-mechanical control system 4 and a FPD mounting system comprising a set of mounting arms 8, 9 arranged generally parallel with the wall brackets. A cross-arm 11 is provided for pivotal attachment to the lower one 9 of the mounting arms 9 and to a distal end of the lower wall bracket 3. The control system 4 is arranged to move the apparatus between a number of positions, including a parked position in which the FPD can be supported almost flush to a wall. Operation of said FPD to an ON state initiates movement of said mounting system away from the wall to permit ventilation. An intermediate position allows for cooling before the FPD is automatically returned to its parked position following an OFF or STANDBY command.

### CROSS-REFERENCES TO RELATED APPLICATIONS

This application claims priority from United Kingdom Application Serial Number 0916563.0 filed Sep. 21, 2009 which is hereby incorporated herein by reference in its entirety.

### TECHNICAL FIELD

This invention relates to a mounting apparatus for a television or display, particularly a flat-panel television or display (FPD).

### BACKGROUND OF THE INVENTION

FPDs are becoming the norm in place of old-style cathode ray tube (CRT) displays. FPDs come in a range of sizes and have the advantage of being much lighter and less bulky than CRTs. There are a number of methods for mounting FPDs, for example using a traditional-style stand or, as is the trend, using wall mountings. Such wall mountings tend to comprise a set of wall-mounted brackets and a set of television brackets which are connected together in such a way as to allow a degree of adjustment in terms of upwards or sideways movement.

A disadvantage associated with conventional wall mounts is that they have to maintain a minimum gap between the television and wall to allow ventilation of the FPD in use. As will be appreciated, electronic devices such as FPDs generate heat and therefore require ventilation through rear grilles to prevent damage to the internal circuitry. Accordingly, wall-mounted FPDs tend to sit quite proud of their supporting wall, usually by at least 100 mm. To improve aesthetics, some users create a recess in the supporting wall into which the FPD is mounted, the depth of the recess allowing for ventilation whilst at the same time allowing the FPD to appear flush to the wall. However, for obvious reasons, this is expensive and not always practical or even possible if the structure of the wall does not allow.

It is an aim of the present invention to provide an improved mounting apparatus.

### BRIEF SUMMARY OF THE EMBODIMENTS OF THE INVENTION

According to one aspect, there is provided mounting apparatus for a flat-panel display or television, the apparatus comprising a wall mount, a television mount and a control system for controlling the relative position of the two mounts, wherein said control system is arranged, in response to receiving a first control signal, to maintain a first predetermined separation between the two mounts for a predetermined period of time and thereafter to reduce the separation between the two mounts.

The control system is preferably electromechanical. For example, the control system may comprise an electric motor coupled to the television mount. The relative position between the television mount and wall mount may be controlled by a microprocessor operating under the control of a program. The microprocessor is operable to control the motor in such a way as to achieve the desired relative position in response to receiving control signals which may be initiated by a user, e.g. a user operating a remote control.

Said apparatus allows a FPD to be operated and viewed at a suitable distance away from the wall to permit ventilation and, in response to receiving a control signal, for example a ‘standby’ or ‘off’ signal, to move to, or maintain, a predetermined separation to allow cooling to take place before automatically reducing the separation after a predetermined time period. The mounting apparatus can therefore be made very low profile in order to mount a FPD very close to its supporting wall. The main obstacle up to now has been the need for ventilation which is herein provided for by an adjustable mount which ensures ventilation in use, suitable cooling immediately after use and then an automatic return to the flush ‘parked’ position after a predetermined cooling period.

The predetermined separation may be between 40 and 110 mm, the lower end being considered the minimum distance required for ventilation.

The separation is preferably reduced after the predetermined cooling period so that the gap between the two mounts is substantially closed in the vertical plane, for example so that the wall mount and the television mount overlap. By overlapping the two mounts, the distance that the FPD will protrude from the supporting wall may simply be the depth of the television mount.

One or each of the two mounts may comprise one or more longitudinal brackets and the electro-mechanical control system can be arranged such that the or each bracket of one mount lies in a different horizontal plane than the or each bracket of the other mount. The control system can include an arm having an articulated coupling to at least one of the mounts. The arm may have an articulated coupling to the wall mount and includes a motor arranged to cause rotation of said coupling to effect movement of the arm relative to the wall mount. The arm may have an articulated coupling to the television mount and the same or a different motor may be arranged to cause rotation of said coupling to effect movement of the television mount relative to the arm.

The control system may be further arranged, in response to receiving a second control signal, to set a second predetermined separation between the two mounts, the second separation being greater than the first separation. This second separation may be associated with a ‘viewing’ position. The apparatus may further comprise programmable means enabling user setting of at least the second separation.

The apparatus may further comprise a receiver arranged to receive the or each control signal from a wireless source. The receiver may be an ultrasonic or infrared receiver.

The articulated coupling may include a torque release mechanism arranged to permit disengagement of the control system from the axle in the event that a predetermined torsion force is externally applied.

According to a second aspect, there is provided mounting apparatus for a flat-panel display or television, the apparatus comprising a wall mount, a television mount and an electro-mechanical control system for controlling the relative position of the two mounts, wherein said control system is arranged, in response to receiving an operating signal, to set the television mount at a first, viewing, position relative to the wall mount, and in response to receiving a standby signal, to change the relative positions of the mounts such that the gap between them is reduced to an intermediate cooling position which is maintained for a predetermined time period after which the gap is reduced still further to locate the television mount in a storage position.

According to a third aspect, there is provided mounting apparatus for a flat-panel display or television, the apparatus comprising a television mount attached to a drive system for rotating the television mount with respect thereto, wherein the apparatus comprises a torque limiting system arranged to disengage the television mount from the drive system in the event that a predetermined torsional force is applied to the television mount.

According to a fourth aspect, there is provided a torque limiting system for use with a flat panel display system.

According to a fifth aspect, there is provided a current control system for preventing closure of the above mechanism or mechanisms in the event that an increase in current is detected at the motor, e.g. due to the closing apparatus being blocked by a child's fingers.

### BRIEF DESCRIPTION OF THE DRAWINGS

The invention will now be described, by way of example, with reference to the accompanying drawings in which:

FIG. 1 is an exploded perspective view of a FPD mounting apparatus according to the invention;

FIG. 2 is a perspective view of the apparatus of FIG. 1 when assembled;

FIG. 3 is a perspective view of the apparatus of FIG. 2 when operated in a viewing position;

FIG. 4 is a perspective view of the apparatus of FIG. 1 with mounting brackets;

FIG. 5 is a top plan view of the apparatus when positioned as shown in FIG. 2;

FIG. 6 is a top plan view of the apparatus when positioned as shown in FIG. 3;

FIG. 7 is a top plan view of the apparatus in an intermediate cooling position;

FIG. 8 is a top plan view of the apparatus in an alternative intermediate cooling position;

FIG. 9 is a transition state diagram indicating the operating states of a control system comprising part of the apparatus according to the invention;

FIG. 10 is a sectional view of the control system shown in the Figures, which is useful for understanding the arrangement of internal components of said control system; and

FIG. 11 is a plan view of part of the control system shown in FIG. 10, which is useful for understanding the operation of an associated safety system.

### DETAILED DESCRIPTION OF THE EMBODIMENTS OF THE INVENTION

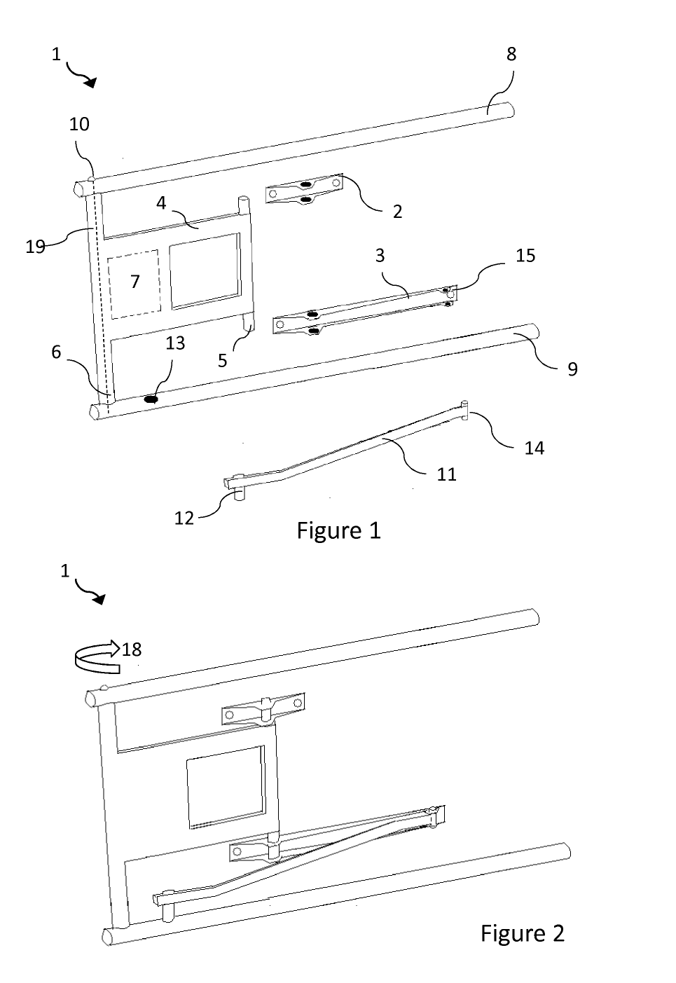

Referring to FIG. 1, a FPD mount apparatus 1 comprises a number of interconnected components which include a set of wall brackets 2, 3, an electro-mechanical control system 4 and a FPD mounting system comprising a set of mounting arms 8, 9 arranged generally parallel with the wall brackets. A cross-arm 11 is provided for pivotal attachment to the lower one 9 of the mounting arms 9 and to a distal end of the lower wall bracket 3. The function of said cross-arm 11 will be explained later on.

The wall brackets 2, 3 have different lengths with the lower bracket 3 being longer than the upper bracket 2. Both brackets 2, 3 include at least first and second end-holes enabling the brackets to be bolted to a wall or other vertical surface. Both brackets 2, 3 are longitudinal and have a generally U-shaped profile along their length in which opposing apertures are provided in the lateral walls for receiving respective ends of a rod 5 forming part of the control system 4. End caps (not shown) are employed to secure the rod 5 in place at either end and allow pivotal rotation of said control system 4 with respect to the wall brackets 2, 3. Near to the distal end of the lower, longer, wall bracket 3 is provided another set of apertures 15 into which a rod 14 of the cross-arm 11 is received to allow rotational movement of said cross-arm with respect to the wall bracket. Again, end caps (not shown) are used to secure the rod 14 in place.

The control system 4 comprises a predominately hollow H-shaped body having, to one side, the above-mentioned rod 5 extending across its width, and at the opposite side, a tubular sleeve 6 within which is located an axle 19 arranged to rotate under the control of an electric motor, gearing and control circuitry 7 internal to the control system 4 body. The FPD mounting arms 8, 9 are attached to the exposed ends of the axle 19 by end-nuts 10.

FIG. 2 shows the above-mentioned components when assembled to form the mounting apparatus 1. It is assumed that the wall brackets 2, 3 will be attached to a generally vertical wall (not shown). In use, rotation of axle 19 in a clockwise direction, as indicated by the arrow 18, causes clockwise rotation of the generally parallel mounting arms 8, 9 in planes perpendicular to the wall. Clockwise rotation of said arms 8, 9 causes counter-clockwise rotation of the control system 4 by virtue of the cross-arm 11 that, due to it being fixed at one end to wall bracket 3, levers the free-end of the control system from the wall.

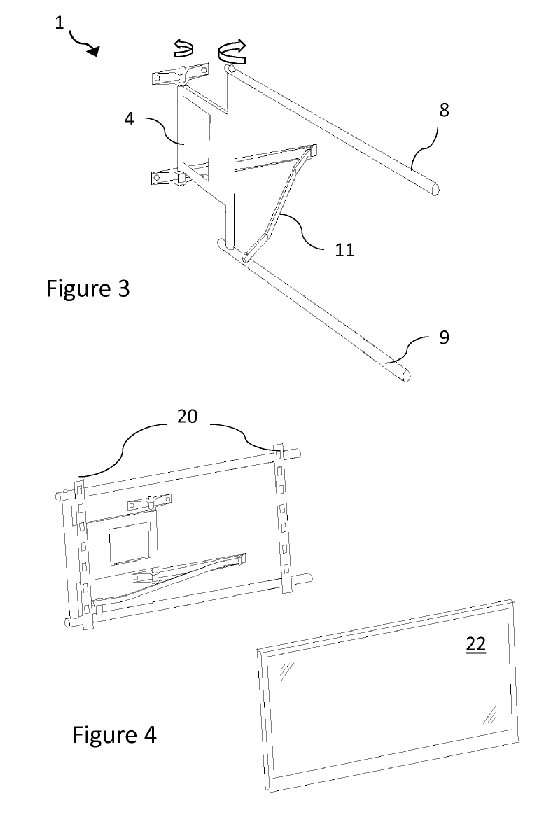

FIG. 3 indicates the position of the various components of the mounting apparatus 1 after a 180° rotation of the FPD mounting arms 8, 9. It will be seen that the mounting arms 8, 9 are in general alignment with the control system 4 which has rotated 90° counter-clockwise so as to be substantially perpendicular to the wall. In this embodiment, this position represents an ‘end’ position beyond which the control system 4 permits no further rotation or extension.

When attached to the mounting arms 8, 9, a FPD is moveable from a so-called ‘parked’ position in which is it parallel and flush with the supporting wall surface (the FIG. 2 position) to a so-called ‘viewing’ position (the FIG. 3 position) in which the FPD is supported remote from the wall to permit clear ventilation through its rear grilles. The viewing position is therefore suited to when the FPD is being operated whereas the parked position is appropriate for when the FPD is switched off. As will be explained later on, a so-called ‘cooling’ position is also defined which is intermediate the viewing and parked positions.

FIG. 3 indicates one such viewing position, although in theory any position away from the parked position can be used. In the case of FIG. 3, the FPD will self-evidently be at right-angles to the supporting wall.

FIG. 4 shows one way in which a FPD 22 can be secured to the mounting arms 8, 9. In this case, vertical brackets 20 are screwed to the mounting arms 8, 9, each bracket having holes for receiving four L-shaped brackets (not shown) protruding from the rear of the FPD 22.

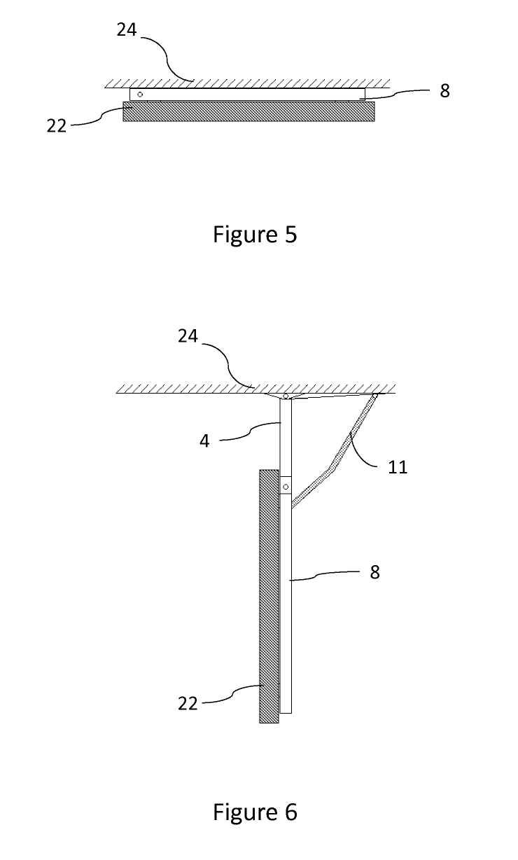

FIGS. 5-8 show the above described apparatus in plan view at various stages between the parked (FIG. 5) and viewing positions (FIG. 6). In FIG. 5, it will be seen that the FPD 22 is supported nearly flush with the supporting wall 24. Indeed, the separation between FPD 22 and wall 24 is due simply to the depth of the mounting apparatus, or rather its thickest part between the wall and FPD. Here, mounting arms 8, 9 represent the thickest part of the apparatus, both being about 30 mm in diameter along their length. As FPDs become lighter and mounting apparatuses made smaller, a near-flush result is easily achieved.

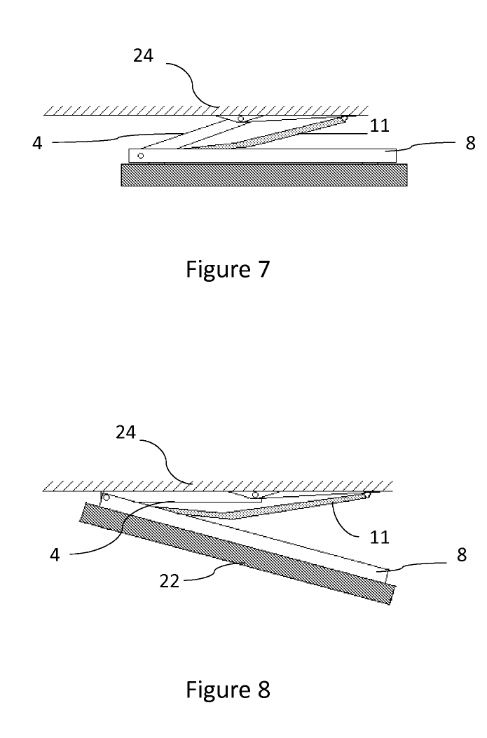

As mentioned above, intermediate the parked and viewing positions is defined a cooling position. In said cooling position, the mounting arms 8, 9 are set at a predetermined distance from the wall. This distance is suitable to allow the mounted FPD 22 to cool down through ventilation following operation. Typically, this distance will be between 40 mm and 110 mm. The intention is that, in use, the user is able to signal to the control system 4 that they are finished watching the FPD 22 and, in response, the control system causes the mounting apparatus automatically to assume the cooling position for a predetermined time period to allow cooling. Following this period, the mounting apparatus automatically returns to the parked position until the next time the user wishes to view the FPD 22. The predetermined time period may be in the order of between 5 and 15 minutes depending on the size and power rating of the FPD. FIG. 7 shows an example cooling position in which the mounting arms 8, 9 (and so FPD 22) are held parallel but clearly remote from the wall. FIG. 8 shows an alternative cooling position in which the mounting arms and FPD 22 are at an angle to the wall but nevertheless sufficiently remote along the majority of the length to permit cooling.

Movement to and from the three positions is performed under the control of the electro-mechanical control system 4. The control system 4 operates in a learn mode and in a run mode.

In the learn mode, the user operates a control panel (which can be a dedicated remote control or a panel on the back of the control system 4) to set the mounting arms 8, 9 and control system 4 to a desired position before storing that position as the viewing position in memory. The same process is repeated to set the cooling position. The parked position is assumed to be the default flush position shown in FIGS. 2 and 5. The predetermined time period (Tc) associated with the cooling position is also set and stored in the learn mode.

Note that the viewing and cooling positions can be identical, provided that that position is maintained for a predetermined cooling period before returning automatically to the parked position.

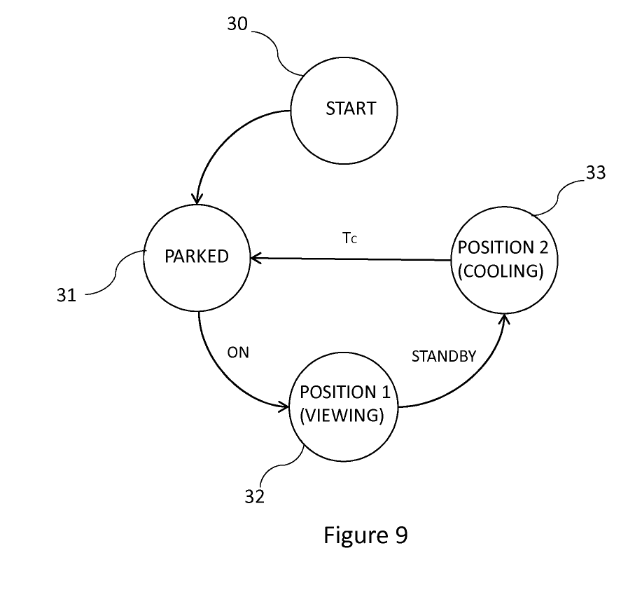

In the run mode, automatic movement of the mounting apparatus 1 between the parked, viewing and cooling positions is performed in response to user commands; these user commands may be issued by means of a dedicated remote control or from the FPD's own remote control. In the latter case, it is necessary to store the ON, OFF or STANDBY signals into the control system's memory. In response to receiving a recognised signal from the remote, a microprocessor within the control system 4 operates according to the transition state diagram of FIG. 9. Referring to FIG. 9, we assume an initial state 30 when the apparatus 1 is in the learn mode. Upon entering the run mode, the apparatus 1 is assumed to be in the parked state 31. Upon receipt of a user-initiated ‘ON’ signal, the control system 4 operates the motor and gearing so that the apparatus 1 assumes the viewing position 32. Upon subsequent reception of a user-initiated ‘OFF’ signal, the control system causes the apparatus 1 to assume the cooling position 33 for the predetermined period Tc after which the returns to the parked state where it is flush with the wall as shown in FIGS. 2 and 5.

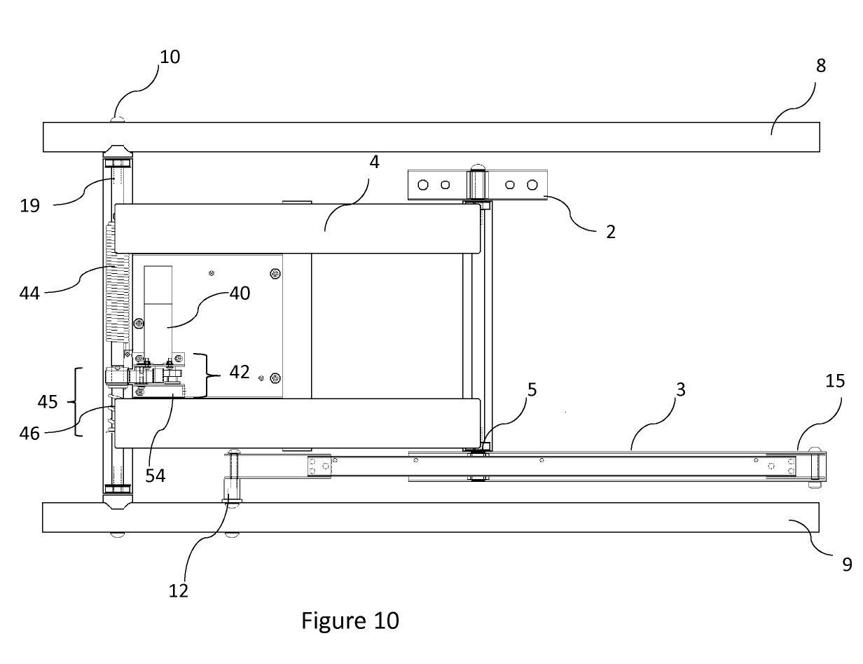

Referring to FIG. 10, the components 7 internal to the control system 4 will now be briefly described. Said components 7 comprise an electric motor 40 which drives a system of gears 42. The gears 42 in turn drive the axle 19 in the clockwise and counter clockwise directions according to control signals received from a microprocessor (not shown). Said microprocessor operates in the learn and run modes described above, depending on user selection. In the learn mode, the microprocessor receives data from a position sensor 54 in order to identify the direction and amount of rotation required from a reference point to reach the viewing and cooling positions. Said rotational settings are stored in solid state memory for use in the run mode, which follows the above-described state transition diagram when said mode is selected.

Further components within the control system 4 include a coil spring 44 located approximately halfway along the axle 19 with a drive gear 46 of the gear system 42 connected to said axle just below the coil spring. Associated with drive gear 46 is a safety mechanism 45 which is provided to prevent damage to the control system 4, particularly if the attached screen is accidentally knocked, the path of the moving parts are blocked or children's fingers become trapped. Regarding the former, given the large size of screens, there will be a large leverage effect if, say, someone were to accidentally lean or fall against the screen.

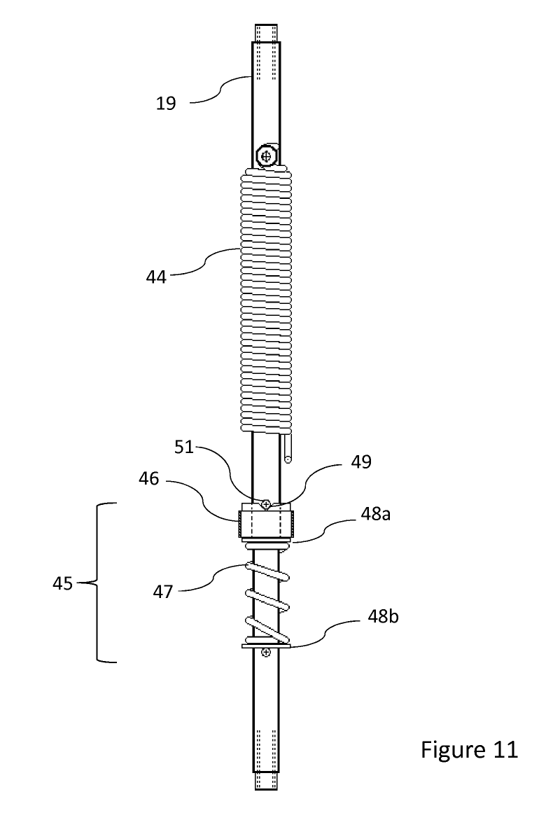

The safety mechanism will now be described with particular reference to FIG. 11.

Referring to FIG. 11, the above-mentioned safety mechanism 45 comprises a second coil spring 47 which extends around the axle 19 and exerts a predetermined upwards force on the drive gear 46 via a movable washer 48a. The coil spring 47 is held in position at its lower end by a further washer 48b which sits on a first screw 50 protruding from axle 19. The drive gear 46 has a V-shaped notch 49 cut in its upper edge which, due to the upwards force of the coil spring 47, engages a screw 51 protruding from the axle 19 to provide the in-use drive engagement between the gear and axle. In the event that an external torsional force is applied to the axle 19, movement of the drive gear 46 against the screw 51 will act to compress the spring 47 downwards. If the force is sufficiently large, the spring compression will cause disengagement of the screw 51 from the notch 49 and so the axle 19 can continue to turn due to the external force without damaging the control system 4, particularly the gears. Re-engagement can be made in a straightforward manner by subsequently rotating the axle to situate the screw 51 in the notch 49.

Alternative safety mechanisms comprising slip clutches or torque limiters to disengage the axle 19 may be used.

A further safety system that may be employed is a current control system which detects an increase in current at the motor which will occur if, for example, the opening or closing of the system, particularly the FPD mounting arms 8, 9, are inhibited by a child's fingers being trapped between different moving parts. On detecting the increase in current at the motor, the control system is arranged to shut the motor off to prevent further opening or closing of the system until the system can be reset, e.g. by turning the power off and on again.

Electrical power for the motor 40, microprocessor and memory is supplied to the control system 4 by a lead extending from a wall-socket transformer (not shown).

The diagonal orientation of the cross-arm 11 makes it particularly useful for carrying leads, for example the power lead and other leads feeding the FPD from the wall, in a convenient and discrete manner. The cross-arm 11 may be tubular, for example with a circular or rectangular cross-section along most of its length, within which can be fed the power, aerial, HDMI and SCART leads from the wall to the back of the FPD. The tubular construction of the cross-arm largely hides said leads regardless of the extension of the mounting apparatus 1 from the wall. Other arrangements for the cross-arm 11 include open channel configurations such as substantially U or H-shaped members in which the leads are nonetheless hidden from view, particularly if tied together with a tie cable.

In summary, there is described a wall-mounting apparatus 1 for a FPD, such as a LCD or plasma television or other form of computer display. Said apparatus 1 is arranged to operate at a number of positions, including a parked position in which the FPD can be supported almost flush to the wall using a small and low profile mounting bracket. Operation of said FPD to an ON state initiates movement of said mounting away from the wall to permit ventilation. An intermediate position allows for cooling before the FPD is automatically returned to its parked position following an OFF or STANDBY command.

What is claimed is:

1. Mounting apparatus for a flat-panel display or television, the apparatus comprising a wall mount, a television mount and a control system for controlling the relative position of the two mounts, wherein said control system is arranged, in response to receiving a first control signal, to maintain a first predetermined separation between the two mounts for a predetermined period of time and thereafter to reduce the separation between the two mounts.

2. Mounting apparatus according to claim 1, in which the relative position between the television mount and wall mount may be controlled by a microprocessor operating under the control of a program.

3. Mounting apparatus according to claim 2, in which the microprocessor is operable to control the motor in such a way as to achieve the desired relative position in response to receiving control signals initiated by a remote control.

4. Mounting apparatus according to claim 1, in which the predetermined separation is between 40 and 110 mm.

5. Mounting apparatus according to claim 1, arranged such that, after the predetermined cooling period, the gap between the two mounts is substantially closed in the vertical plane so that they at least partially overlap.

6. Mounting apparatus according to claim 5, wherein one or both mounts comprise a longitudinal bracket and the electro-mechanical control system is arranged such that the or each bracket of one mount lies in a different horizontal plane than the or each bracket of the other mount.

7. Mounting apparatus according to claim 1, in which the control system includes an arm having an articulated coupling to at least one of the mounts.

8. Mounting apparatus according to claim 7, in which the arm has an articulated coupling to the wall mount and the control system further includes a motor arranged to cause rotation of said coupling to effect movement of the arm relative to the wall mount.

9. Mounting apparatus according to claim 1, in which the control system is further arranged, in response to receiving a second control signal, to set a second predetermined separation between the two mounts, the second separation being greater than the first separation.

10. Mounting apparatus according to claim 9, further comprising programmable means enabling user setting of at least the second separation.

11. Mounting apparatus according to claim 1, further comprising a receiver arranged to receive the or each control signal from a wireless source.

12. Mounting apparatus according to claim 7, in which the articulated coupling includes a torque release mechanism arranged to permit disengagement of the control system from the mount to which it is connected in the event that a predetermined torsion force is externally applied.

13. Mounting apparatus according to claim 1, further comprising a current control system for preventing closure between the mounts in the event that an increase in current is detected.

14. A computer program stored on a computer readable medium, the program comprising computer readable instructions arranged, when run on a processor, to control the separation of the mounting members as defined in claim 1.

15. Mounting apparatus for a flat-panel display or television, the apparatus comprising a wall mount, a television mount and an electro-mechanical control system for controlling the relative position of the two mounts, wherein said control system is arranged, in response to receiving an operating signal, to set the television mount at a first, viewing, position relative to the wall mount, and in response to receiving a standby signal, to change the relative positions of the mounts such that the gap between them is reduced to an intermediate cooling position which is maintained for a predetermined time period after which the gap is reduced still further to locate the television mount in a storage position.

16. A computer program stored on a computer readable medium, the program comprising computer readable instructions arranged, when run on a processor, to control the separation of the mounting members as defined in claim 15.

17. Mounting apparatus for a flat-panel display or television, the apparatus comprising a television mount attached to a drive system for rotating the television mount with respect thereto, wherein the apparatus comprises a torque limiting system arranged to disengage the television mount from the drive system in the event that a predetermined torsional force is applied to the television mount.
